(19) United States
(12) Patent Application Publication
(10) Pub. No.: US 2018/0243975 A1
(43) Pub. Date: Aug. 30, 2018

(54) BUILDING PLATFORM SUBSTRATE FOR 3D PRINTING

(71) Applicant: Hewlett-Packard Development Company, L.P., Houston, TX (US)

(72) Inventors: Bor-Jiunn Niu, San Diego, CA (US); Xulong Fu, San Diego, CA (US); Christine E. Steichen, Escondido, CA (US); Robert Beauchamp, Sant Cugat del Valles (ES); Morad M. Samii, La Jolla, CA (US)

(21) Appl. No.: 15/754,559

(22) PCT Filed: Oct. 29, 2015
(86) PCT No.: PCT/US2015/058052

§ 371 Date: Feb. 22, 2018

(51) Int. Cl. B29C 64/118; B29C 64/40; B29C 47/00

(52) U.S. Cl. CPC B29C 64/118; B33Y 30/00; B29C 47/0014; B29C 64/40

(57) ABSTRACT

A building platform substrate for 3D printing in a Fused Filament Fabrication (FFF) 3D printer is disclosed. The platform substrate includes a paper layer that is re-pulpable in water, a water-soluble top coat layer on one side of the paper layer, a water-soluble adhesive layer on an other side of the paper layer, and a lay flat release liner on an exposed surface of the adhesive layer. A 3D printer having a removable Z-axis platen for accepting the building platform substrate and a method of manufacturing the platform substrate are also disclosed.

### BACKGROUND

Three-dimensional (3D) printing, also known as additive manufacturing (AM) may be used to fabricate a three-dimensional object of almost any shape from a 3D model or other electronic data source primarily through additive processes in which successive layers of material are laid down. The properties of the three-dimensional object may vary depending on the materials used as well as the type of additive manufacturing technology implemented.

3D printing, along with other additive manufacturing and rapid prototyping (RP) techniques, involves building up structures in a layer by layer fashion based upon a computer design file. Such techniques are well suited to the production of one-off, complex structures that would often be difficult or impossible to produce using traditional manufacturing or prototyping methods. There have been both rapid growth and interest in this field during recent years and a range of techniques is now available which make use of many common materials such as plastic, metal, wood, and ceramic.

More specifically, solid Fused Filament Fabrication (or layer manufacturing) can be defined generally as a fabrication technology used to build a three-dimensional object using layer by layer or point-by-point fabrication. With this fabrication process, complex shapes can be formed without the use of a pre-shaped die or mold.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view of a platform substrate, according to an example;

FIG. 2 is a diagrammatic view of a portion of a Filament Feed Fabrication (FFF) 3D printer that incorporates the platform substrate shown in FIG. 1, according to an example;

FIG. 3 is a flow chart depicting an example method of making the platform substrate; and

FIG. 4 is a flow chart depicting an example method of using the platform substrate in the FFF 3D printer.

### DETAILED DESCRIPTION

Fused Filament Fabrication (FFF), also known as Filament Feed Fabrication, is an additive manufacturing technology commonly used for modeling, prototyping, and production applications. FFF works on an “additive” principle by laying down material in layers. A filament of plastic or other material is unwound from a coil and supplies material to an extrusion nozzle which can turn the flow on and off. The nozzle is heated to melt the material and can be moved in both horizontal and vertical directions by an X-Y-Z control system. In some cases, the nozzle may be moved in the X and Y directions and a platen, on which the model or part is formed, may be moved in the Z direction. The part may be produced by extruding beads of thermoplastic material to form layers as the material hardens immediately after extrusion from the nozzle. Stepper motors or servo motors may be employed to move the extrusion head and platen. For areas not intended to become part of the model, other support, or scaffolding, materials may be used in the layering. These support materials can be mechanically removed or dissolved after printing and solidification is finished.

All FFF 3D printers may require a solid controllable platen to build the part on, as compared to powder base systems, in which the powder acts as the building platform. All existing systems may have used a variety of solutions such as expensive disposable platen trays, expensive Z axis platforms, or other costly disposable covering materials to provide the adhesion to the Z-axis indexing platform, and flatness requirement for the 3D parts being fabricated.

The FFF printer prints a 3D object by extruding a stream of heated or melted thermoplastic material, which is carefully positioned into layer upon layer, working from the bottom up. By adding layer upon layer, which will almost immediately harden upon leaving the hot print head, the object begins to materialize.

At the time of filing this application, one time use platen solutions tend to cost from $1.85 to $3.00 to manufacture, and retail for $4.00 to $6.00 each (single use). Other alternatives, such as exotic polymer self-adhesive films, last for multiple parts (3 to 6 parts average, depending on the part size and materials used to fabricate the part), and cost roughly between $1.00 to $2.00 to manufacture and retail for $2.00 to $4.00 per application.

This disclosure addresses a system solution for a permanent removable heated platform, which then receives a one-time use platform substrate. The platform substrate may be a water-soluble, removable, pressure-sensitive adhesive-backed paper layer that, due to the nature of its coating, provides a very stable adhesion surface for the scaffolding and/or the build materials, e.g., acrylonitrile-butadiene-styrene (ABS) of a 3D part. The platform substrate may then be separated from the formed part by placing them into a water-only scaffold removal tank to return the paper-based platen substrate to pulp.

In accordance with the teachings herein, a building platform substrate for 3D printing in a Fused Filament Fabrication (FFF) 3D printer is provided. The platform substrate includes:

a paper layer that is re-pulpable in water;

a water-soluble top coat layer on one side of the paper layer;

a water-soluble adhesive layer on an other side of the paper layer; and

a lay flat release liner on the adhesive layer.

The building platform substrate may include a paper layer that is readily re-pulpable in water. On one side of the paper layer may be formed a water-soluble top coat layer to which a part being built, such as by FFF, may be adhered. On the other side of the paper layer may be a water-soluble adhesive layer, on which a lay flat release liner may be laminated. The adhesive layer is intended for attachment of the building platform substrate to a removable Z-axis platen for 3D printing. The lay flat release liner may be removed prior to placing the platform substrate on the platen.

A variety of existing standard papers, broadly available in the industry, may be employed as the base substrate to which the water-soluble top coat layer may be applied for adhering the build materials and/or the scaffolding materials, i.e., the part and its supporting structure. To the other side of the coated substrate may be applied the water-soluble adhesive layer, which may be a water-soluble, high tack adhesive (similar to water-soluble stamp or bottle label adhesives). As mentioned above, a removable release liner may be applied to the water-soluble adhesive layer. In an example, these layers may compose the entire pressure-sensitive, water-removable platform substrate.

There are four main functions that examples of the platform substrate disclosed herein are to perform:
adhere to the heated Z-axis platen,
allow part and scaffolding material to adhere to the substrate surface,
be strong enough to keep parts flat until they cool and anneal, and
provide easy water-only clean up from the Z-axis platen and the part.
   These attributes may be needed mainly during the parts build and cooling/annealing.

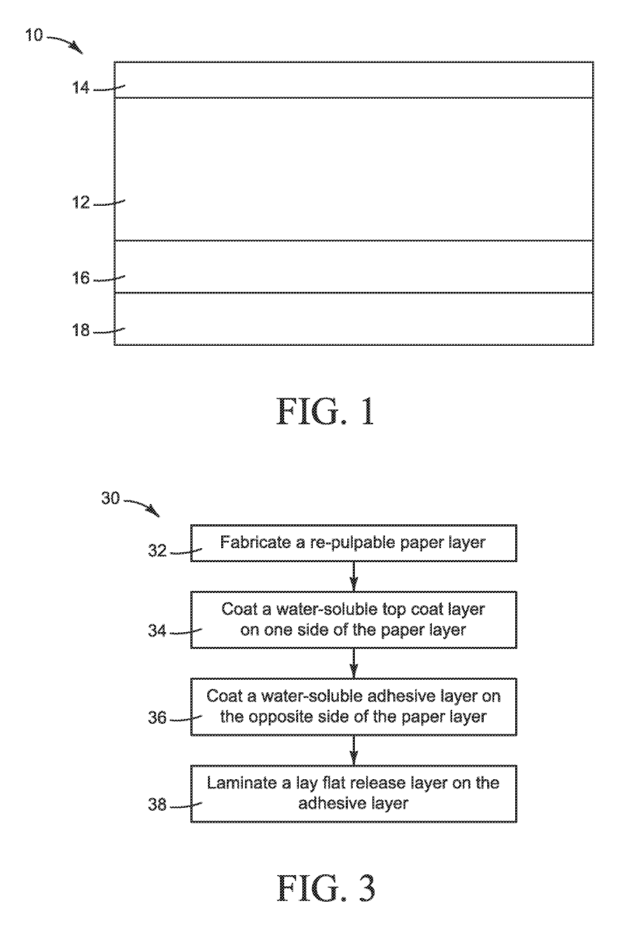

A cross-sectional view of an example platform substrate 10 is shown in FIG. 1, which shows the various layers of the platform substrate. The various layers are now described in more detail.

A paper layer 12 may be fabricated on a typical paper-making machine to various thicknesses and calendering levels. One noteworthy aspect of this type of paper is the elimination of much of the wet strengthening agents in order to be easily wettable. Once wetted, the paper structure rapidly returns back into its pulp form. Accordingly, the paper layer 12 is called “re-pulpable” in water.

The paper (or pulp) base (or substrate) layer 12 may be formed to a basis weight within a range of about 60 grams per square meter (gsm; g/m²) to about 250 gsm. The thickness of the pulp substrate plain paper 12 may be within a range of about 60 μm to about 250 μm, noting that 1 gsm is approximately equal to 1 μm.

A water-soluble top coat layer 14, coated on one side of the paper layer 12, may function as a tie, or adhesive, layer between the 3D printed part, such as with an ABS material, and the paper layer, or pulp base, 12. An example of the water-soluble top coat layer 14 includes a combination of binder and pigment. Various binder and pigment combinations have been tested.

In an example, binders suitable for layer 14 may be chosen from polyvinyl alcohol (PVOH) and starch-based binders or a combination thereof. It is to be understood that any suitable binder composition materials alone or in combination may be employed within the water-soluble top coat layer 14. Some examples include polyvinyl alcohol (PVOH), reactive PVOH (such as acetoacetyl modified PVOH), cationically modified PVOH (such as amine or ammonium modified PVOH), anionically modified PVOH, hydrophilic group modified PVOH, PVOH-copolymer polyethylene oxide (PEO), polyacrylate modified PVOH, polyvinylpyrrolidone (PVP), polyurethane, the copolymer of PVP and polyvinyl acetate, hydroxypropylcellulose, ethoxylated cellulose, polyester, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and/or derivatives thereof, and/or mixtures thereof. Some commercially available examples of PVOH binders include Poval 235, Poval 245, Mowiol 6-98, Mowiol 20-98, and Mowiol 40-88 (all from Kuraray, Inc.), and Celvol® 107 Polyvinyl Alcohol and Celvol® 310 Polyvinyl Alcohol (from Sekisui Specialty Chemicals U.S.).

Some examples of additional binders which may be employed in the top coat layer 14 include starch, alginates, carboxycellulose materials (for example, methyl-hydroxypropyl cellulose, ethylhydroxypropyl cellulose, and the like), polyacrylic acid and derivatives thereof, polyvinyl pyrrolidone, casein, polyethylene glycol, polyurethanes (for example, a water-soluble or water-dispersible polyurethane polymer/resin dispersion), polyamide resins (for instance, an epichlorohydrin-containing polyamide), poly(vinyl acetate-ethylene) copolymer, poly(vinyl pyrrolidone-vinyl acetate) copolymer, and mixtures thereof.

In an example, the concentration of binder may be within a range of about 50 weight percent (wt %) to about 99 wt % in the water-soluble top coat 14, based on dry weight. In another example, the concentration of binder may be within a range of about 60 wt % to about 90 wt % in the water-soluble top coat 14. In yet another example, the concentration of binder may be within a range of about 70 wt % to 85 wt % in the water soluble top coat 14.

A pigment may be suspended in the binder of the top coat layer 14. Some pigments that may be employed in connection with the top coat layer 14 include boehmite, pseudo-boehmite, silica (in precipitated, colloidal, gel, sol, and/or fumed form), cationic-modified silica (e.g., alumina-treated silica), cationic polymeric binder-treated silica, magnesium oxide, polyethylene beads, polystyrene beads, magnesium carbonate, calcium carbonate, barium sulfate, clay, titanium dioxide, gypsum, and mixtures thereof.

In an example, the pigment chosen for layer 14 is fumed silica. The fumed silica can be non-surface treated or surface treated. The surface treated silica can be treated with organic materials or inorganic materials, or a combination thereof. In examples of surface treated silica, the fumed silica may be treated with aluminum chlorohydrate (ACH) or silane coupling agents containing amino functional groups, or a combination of both. The silane coupling agents may contain functional groups such as primary amine, secondary amine, tertiary amine, quaternary amine, etc.

In an example, water-soluble top coat layer 14 includes surface-treated fumed silica suspended/dispersed within PVOH. In some examples, PVOH may be employed due to its adhesion properties to the paper base 12 and to the fumed silica. An amount of the top coat layer 14 material on the pulp base layer 12 may be within a range of about 10 gsm to about 40 gsm. The thickness of the top coat layer 12 may be within a range of about 10 μm to about 40 μm.

A water-soluble adhesive layer 16 may be coated on the opposite side of the pulp substrate 12 (opposite side from the top coat layer 14). The adhesive layer 16 may be a high tack, water-soluble adhesive, such as used in bottle labeling and in postage stamps. A high tack adhesive is one that forms a bond when pressure is applied to marry the adhesive to the adherend. For example, the adhesive layer 16 may be an acrylic-based or polyurethane-based adhesive.

The adhesive used to form adhesive layer 16 is a water-based adhesive, such as, for example, an aqueous-based water-soluble and/or water-dispersible adhesive. By water-dispersible is meant particles that are invisible to the naked eye. In an example, the adhesive may be formed of a synthetic polymer with a weight average molecular weight ranging from about 200,000 to about 800,000 when the structure is linear, or ranging from about 300,000 to about 1,500,000 when the structure is branched or cross-linked. As mentioned above, the adhesive may also have a pressure sensitive nature. For example, the adhesive may have a glass transition temperature (T_{g}) ranging from about −70° C. to about −40° C., and a peeling strength from about 1 Newton/cm² (N/cm²) to about 50 N/cm² (e.g., as measured according to an ASTM (f.k.a. the American Society for Testing and Materials) test method, namely ASTM 3330M using an INSTRON® tester). In some examples, the peeling strength may be about 5N/cm² to about 30 N/cm², and in some other examples, about 10 N/cm² to about 30 N/cm².

As the name indicates, pressure sensitive tapes need pressure to ensure bonding. The recommended bonding pressure is 14.5 to 29 psi=10 N/cm² to 20 N/cm². The pressure may be needed to ensure that the tape comes in close contact to the surface so that the physical forces between the adhesive and the surface can build up. The tape may be applied at moderate temperatures between about 15° C. (59° F.) and about 35° C. (95° F.). Lower temperatures may lead to insufficient “wetting” (coverage) of the adhesive on the substrate. Higher temperatures may cause the tape to stretch when being applied, which could create additional stress in the final application.

Some examples of the adhesive that may be used to form adhesive layer 16 include polyacrylates, polyvinyl ethers, silicone resins, polyacrylic resins, and polyurethanes (for example, a water-soluble or water-dispersible polyurethane polymer/resin dispersion). Some suitable adhesives may be polymers of acrylate addition monomers, such as C1 to C12 alkyl acrylates and methacrylates (e.g., methyl acrylate, ethyl acrylate, n-propyl acrylate, isopropyl acrylate, n-butyl acrylate, isobutyl acrylate, sec-butyl acrylate, tert-butyl acrylate, 2-ethylhexyl acrylate, octyl acrylate, methyl methacrylate, ethyl methacrylate, n-propyl methacrylate, isopropyl methacrylate, n-butyl methacrylate, isobutyl methacrylate, sec-butyl methacrylate, and tert-butyl methacrylate); aromatic monomers (e.g., styrene, phenyl methacrylate, o-tolyl methacrylate, m-tolyl methacrylate, p-tolyl methacrylate, and benzyl methacrylate); hydroxyl containing monomers (e.g., hydroxyethylacrylate and hydroxyethylmethacrylate); carboxylic acid containing monomers (e.g., acrylic acid and methacrylic acid); vinyl ester monomers (e.g., vinyl acetate, vinyl propionate, vinylbenzoate, vinyl pivalate, vinyl-2-ethylhexanoate, and vinyl-versatate); vinyl benzene monomers; and C1-C12 alkyl acrylamide and methacrylamide (e.g., t-butyl acrylamide, sec-butyl acrylamide, N,N-dimethylacrylamide).

The adhesive used for adhesive layer 16 may be a copolymer of at least two of the monomers listed herein. In an example, the molecular structure of the formed copolymer has soft segments (T_{g} ranging from about −70° C. to about −20° C.) and small hard segments (T_{g} ranging from about −10° C. to about 100° C.). The copolymer may also include functional monomers, i.e., the chemical groups on the molecular chain can react to form a cross-linked structure. Examples of functional monomers include methacrylic acid, acrylic acid, glycidyl methacrylate, and hydroxyethyl acrylate.

There is a large selection of suitable commercially available, water-soluble, high tack adhesives, with coat weights within a range of about 5 gsm to about 70 gsm, depending on the formulation and curing of the adhesive layer. In some examples, the coat weight may be within a range of about 5 gsm to about 50 gsm, and in some other examples, from about 5 gsm to about 40 gsm. In yet another example, the coat weight may be within a range of about 40 gsm to about 70 gsm. Examples of three adhesives that may be employed in the practice of the teachings herein may include GS 5800, which is an acrylic polymer emulsion, available from Avery Dennison, Mentor, Ohio; and GS 2417 and GS 3158, which are acrylic adhesives available from Henkel, Bridgewater, N.J. The thickness of the adhesive layer 16 may be within a range of about 5 μm to about 25 μm.

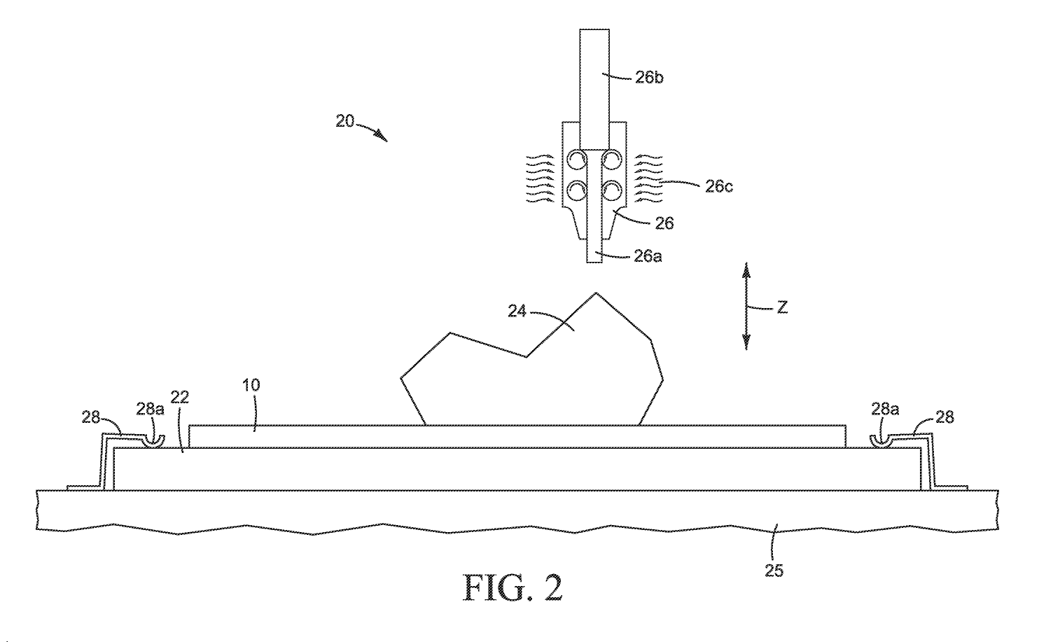

A release liner 18 (e.g., a lay flat release liner) may be laminated on/applied to the exposed surface of the adhesive layer 16. A variety of options are again commercially available, and a lay flat functionality may be employed for ease of handling, since a function of the release liner 18 is to protect the adhesive layer 16 until it is ready to be put on the Z-axis platen (described further below in connection with FIG. 2). The release liner 18 may include a substrate and release coating deposited on the release liner 18. The substrate may be a cellulose paper and/or a polymeric film, such as polyethylene (high or low density), polypropylene, polyvinyl chloride, or polyethylene terephthalate (PET). In an example, the release liner 18 substrate may be a paper, such as Kraft paper. The release coating is made of material(s) that is/are readily able to delaminate from the adhesive layer and do not migrate or transfer to the released material (i.e., adhesive layer 16) to any significant degree. Examples of the release coating of the release liner include polyacrylates, carbamates, polyolefins, fluorocarbons, chromium stearate complexes, wax, and silicones. In one example, the silicone release coating may be desirable, at least in part because it can easily be applied on various substrates and can be cured into a polydimethylsiloxane (PDMS) network, which limits migration into an adhesive matrix. Silicones may also allow substantially lower release forces than other materials.

One example release liner is a polyethylene lay flat release liner of various base weights (i.e., 10 pounds, 11 pounds, etc.), available from Avery Dennison, Mentor, Ohio. In an example, the lay flat release liner 18 may be coated with a silicone release compound) on one side (the side in contact with the adhesive layer 16) so as to release from the adhesive layer 16 and not permanently adhere to it. The adhesive layer 16 and the release liner 18 may use commercially available materials.

FIG. 2 is a schematic diagram, showing a portion of a FFF 3D printer 20 including the platform substrate 10 for in use on a removable Z-axis platen 22 with a fabricated part 24 being built on it. For clarity, the individual layers 12, 14, 16 of the platform substrate 10 are not shown in FIG. 2. It will be appreciated that the lay flat liner 18 has been removed prior to attachment of the platform substrate 10 to the removable Z-axis platen 22. Movement in the Z direction is indicated by the double headed arrow Z. A nozzle 26 feeds melted filament 26a to the part 24, the filament being fed from a source 26b and heated by a heater 26c. The source 26b may be a resin filament or resin pellets. The nozzle 26 may be above the part 24 being made and translatable in the X-Y-Z direction. The platen 22 may be translatable in the X-Y-Z-direction. In many FFF 3D printers, the nozzle 26 may be translatable in the X-Y direction and the platen may be translatable in the Z direction.

The platform substrate 10 may have the structure shown in FIG. 1 (minus the release liner 18 once the platform substrate is adhered to the removable Z-platen 22). The removable Z-axis platen 22 may be reusable. The Z-axis platen 22 may be removable from the 3D printer 20 for easy securing the platform substrate 10 thereto and for removing the platform substrate with finished part 24. Retainers 28 may serve to hold the Z-axis platen in place.

The physical strength of the platform substrate 10 may be realized from the basis weight of the pulp-based sheet 12 and the level of calendaring. Essentially, the heavier the basis weight of the pulp substrate 12 and the thicker the calendered pulp substrate, the higher is its strength and stiffness. This, in turn, determines the strength and stiffness of the total platform substrate 10, and thereby the resultant minimization in warp of the part 24 during part 24 buildup and subsequent cool down. The removability of the part 24 is accomplished by only using water to remove the soluble stack of the platform substrate 10 from the part. The water-dispersible pulp 12, once introduced to water, will lose its strength and be easily removed from the platen 22. The water-dispersible pulp 12, along with the water-soluble top coat layer 14, the water-soluble adhesive layer 16, and the scaffolding material, can be discarded in a conventional waste water stream (much like toilet paper).

An example method 30 for manufacturing the platform substrate 10 is depicted in FIG. 3. In the method 30, the paper layer 12 may be fabricated 32. The paper layer 12 that is formed may have none or only small amounts of wet strength agents, typically less than about 0.5 wt % based on dry pulp, so as to be readily re-pulpable in water.

The method 30 may continue with coating 34 the water-soluble top coat layer 14 on one side of the paper layer 12. The water-soluble top coat layer 14 can be applied on the one side of the paper by any of coating processes, such as, but not limited to, Mayer rod, gravure, slot die, curtain, and blade coating processes. The top coat layer 14 may be applied as part of an in-line process or off-line.

The method 30 may continue with coating 36 the water-soluble adhesive layer 16 on the opposite side of the paper layer 12. The adhesive layer 16 may be applied by any of the above-listed coating processes. Further, the adhesive layer 16 may be applied as part of an in-line process or off-line.

The method 30 may conclude with laminating 38 the lay flat release liner 18 on the adhesive layer 16. The lay flat release liner 18 may be pre-coated with silicone releasing compound or the silicone releasing compound may be applied as part of an in-line process prior to the lamination step.

The paper platform substrate 10 may be cut to size and repackaged. Once so processed, it may be ready to use in conjunction with a FFF 3D printer, such as 3D printer 20.

One example of a platform substrate 10 may be a 250 gsm (250 μm thick) paper layer, 24 gsm (˜24 μm thick) top coat consisting of PVOH and silica layer, with a 10 gsm (˜10 μm thick) adhesive layer and silicone-based release liner. Another example may be a 200 gsm (˜200 μm thick) paper layer, 40 gsm (˜40 μm thick) top coat consisting of PVOH and silica layer, with a 20 gsm (˜20 μm thick) adhesive layer and release liner.

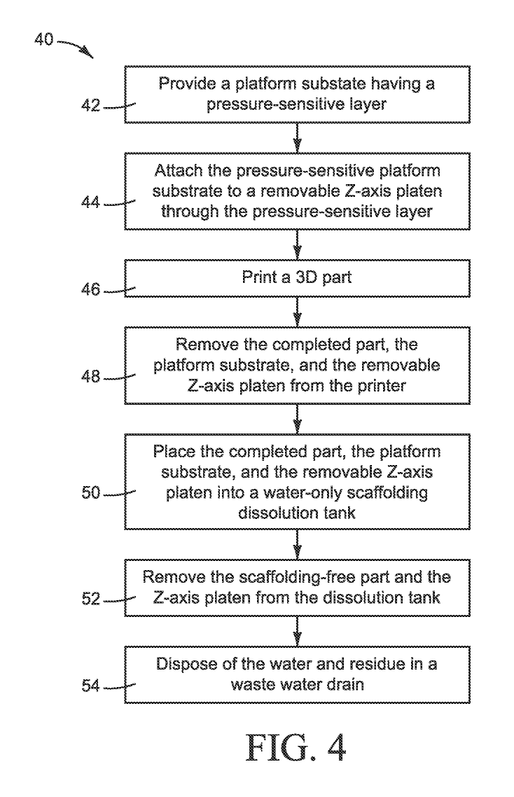

An example method 40 for fabricating a part 24 using a FFF 3D printer 20 is shown in FIG. 4. In the method, a platform substrate 10 may be provided 42. The platform substrate 10 may have the structure as depicted in FIG. 1.

The platform substrate 10 may be attached 44 to the removable Z-axis platen 22. For ease, the Z-axis platen 22 may be removed from the FFF 3D printer 20. The lay flat release liner 18 may be removed from the platform substrate 10, thereby exposing the pressure-sensitive layer 16. Attachment of the platform substrate 10 to the Z-axis platen 22 may be done by pressing the exposed pressure-sensitive adhesive layer to the surface of the removable Z-axis platen.

The 3D part 24 may then be printed 46. Printing may be done using Filament Feed Fabrication procedures. If the Z-axis platen 22 has been removed from the printer 30 in order to attach the platform substrate 10, then it may first be returned to the printer before printing. The 3D printer may not print unless both the platen 22 and the attached platform substrate 10 are in place.

Upon completion of the printing, the completed part 24, the platform substrate 10, and the Z-axis platen 22 may be removed 48 from the 3D printer and placed 50 in a water-only scaffolding dissolution tank. The water may cause re-pulping/dissolution of the platform substrate 10. The part 24, free of scaffolding, and the platform substrate 10, may then be removed 52 from the dissolution tank

The method 40 may be completed by disposing 54 the water and residue from layers 12, 14, 16, and the scaffolding material in a suitable waste water drain.

This method 40 can be repeated indefinitely with the removable Z-axis platen 22 and the one-time use platform substrate 10. Each time, a new platform substrate 10 may be provided, adhered to the removable Z-axis platen 22 via the pressure-sensitive adhesive layer 16, and removed by water rinse.

The cost of the platform substrate 10 may be considerably less than current solutions available today. Advantageously, the use of a water-disposable platform substrate 10 is environmentally friendly. At most, the waste consists of about 1% to 20% of bio-degradable paper, fumed silica, and PVOH, based on wet weight. Further, use of an all water-removable system eliminates the need for solvents or pH-modified water. The disclosed platform substrate 10 is totally removed by water in several minutes, usually about 20 to 30 min. Warm water, such as about 150° C., can remove the platform substrate 10 somewhat faster.

Reference throughout the specification to “one example”, “another example”, “an example”, and so forth, means that a particular element (e.g., feature, structure, and/or characteristic described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 50 to about 99 should be interpreted to include not only the explicitly recited limits of about 50 to about 99, but also to include individual values, such as 60, 90, etc., and sub-ranges, such as from about 70 to about 85, etc. Furthermore, when “about” is utilized to describe a value, this is meant to encompass minor variations (up to ±10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A building platform substrate for 3D printing in a Fused Filament Fabrication (FFF) 3D printer, the platform substrate including:
a paper layer that is re-pulpable in water;
a water-soluble top coat layer on one side of the paper layer;
a water-soluble adhesive layer on an other side of the paper layer; and
a lay flat release liner on the adhesive layer.

2. The building platform substrate as defined in claim 1 wherein the paper layer is re-pulpable by the elimination of all or most of the wet strengthening agents in order for the paper layer to be easily wettable by water to return back to its pulp form.

3. The building platform substrate as defined in claim 1 wherein the paper layer is formed to a basis weight within a range of about 60 gsm to about 250 gsm.

4. The building platform substrate as defined in claim 1 wherein the top coat layer is a tie layer between a part being 3D printed and the paper layer and comprises a binder and a pigment.

5. The building platform substrate as defined in claim 1 wherein the top coat layer material comprises a combination of a binder chosen from polyvinyl alcohol (PVOH) and starch-based binders or a combination thereof and a pigment of fumed silica, suspended in the binder, in which a concentration of PVOH is within a range of about 50 wt % to about 99 wt %.

6. The building platform substrate as defined in claim 1 wherein the adhesive layer is a high tack material chosen from polyacrylates, polyvinyl ethers, silicone resins, polyacrylic resins, and polyurethanes.

7. The building platform substrate as defined in claim 6 wherein the adhesive layer has a coat weight within a range of 5 gsm to 70 gsm.

8. The building platform substrate as defined in claim 1 wherein the release liner is a paper or plastic film coated with a silicone releasing compound on a side in contact with the adhesive layer so as to protect the adhesive layer until the platform substrate is ready to be put on a removable Z-axis platen in the 3D printer.

9. In a Filament Feed Fabrication 3D printer for printing parts, in which the printer includes a removable Z-axis platen for vertical translation, the removable Z-axis platen for accepting a building platform substrate on which the part is to be built, the building platform substrate including:
a coated paper layer on which the part is to be adhered, the paper layer being re-pulpable in water;
a water-soluble top coat layer on one side of the paper layer that the part is to be fabricated on; and
a water-soluble adhesive layer on an other side of the paper layer for adhering to the removable Z-axis platen.

10. The 3D printer as defined in claim 9 wherein the paper layer is re-pulpable by the elimination of much of the wet strengthening agents in order to be easily wettable by water to dissolve back into its pulp form and wherein the paper layer is formed to a basis weight within a range of about 60 gsm to about 250 gsm.

11. The 3D printer as defined in claim 9 wherein the top coat layer is a tie layer between a part being 3D printed and the paper layer and comprises a binder and a pigment, wherein the binder chosen from polyvinyl alcohol (PVOH) and starch-based binders or a combination thereof and the pigment is fumed is within a range of about 50 wt % to about 99 wt %.

12. The 3D printer as defined in claim 9 wherein the adhesive layer is a high tack material chosen from polyacrylates, polyvinyl ethers, silicone resins, polyacrylic resins, and polyurethanes and wherein the adhesive layer has a coat weight within a range of 5 gsm to 25 gsm.

13. A method for manufacturing a platform substrate for use in a Fused Filament Fabrication (FFF) 3D printer, the method including:
fabricating a paper layer;
coating a water-soluble top coat layer on one side of the paper layer;
coating a water-soluble adhesive layer on the opposite side of the paper layer; and
laminating a lay flat release liner on the adhesive layer.

14. The method as defined in claim 13 wherein the paper layer that is formed has few if any wet strengthening agents, so as to be readily re-pulpable in water.

15. The method as defined in claim 14 wherein the paper layer, the top coat layer, and the adhesive layer are re-pulpable/dissolvable in water.
